(19) United States
(12) Patent Application Publication
(10) Pub. No.: US 2002/0167218 A1
(43) Pub. Date: Nov. 14, 2002

(54) Use of steering control to produce deceleration in a vehicle while remaining on a straight ground path

(76) Inventor: Erik Christopher Chubb, Royal Oak, MI (US)

Correspondence Address: PRICE, HENEVELD, COOPER, DEWITT & LITTON, 695 KENMOOR S.E., P. O. BOX 2567, GRAND RAPIDS, MI, 49501-2567, US

(21) Appl. No.: 09/851,804

(22) Filed: May 9, 2001

(51) Int. Cl. B60T 13/00

(52) U.S. Cl. 303/5; 303/9.61

(57) ABSTRACT

A braking system for a vehicle having a pair of primary steering members, each primary steering member being independently steered. Each of the primary steering members further has a primary steering direction. The primary steering directions of the primary steering members are adapted to be substantially parallel when the vehicle is not braking. The primary steering directions of the primary steering members are further adapted to be substantially parallel to a direction of travel of the vehicle when the vehicle is not braking. However, the primary steering directions of the primary steering members are non-parallel during braking of the vehicle. Furthermore, the primary steering directions of the primary steering members are nonparallel to the direction of travel during braking of the vehicle. Therefore, the braking system provides a force to the vehicle opposite to the direction of travel to slow the vehicle.

### BACKGROUND OF THE INVENTION

The present invention relates to braking of a vehicle, and in particular to braking of a vehicle when the primary braking system of the vehicle at least partially fails.

Heretofore, primary braking systems of vehicles have included a brake pedal communicating with a braking element to force the braking element into contact with the rotating wheels of the vehicle to slow the vehicle. Typically, pistons force the braking element into contact with a drum or disc connected to the wheels to slow the rotation of the wheels with friction. Furthermore, the pistons are commonly actuated by hydraulic pressure that forces the braking element into contact with the wheels. When the brake pedal is depressed, the hydraulic pressure causes the brake element to move into contact with the wheels to thereby inhibit rotation of the wheels. However, when the pistons experience loss of hydraulic pressure, depression of the brake pedal will not cause the braking element to come into contact with the wheels. Consequently, the driver of the vehicle cannot prevent rotation of the wheels. In this situation, the driver of the vehicle typically puts the transmission of the vehicle into neutral such that the wheels of the vehicle are not forced to rotate and the driver slowly applies a parking brake to slow the vehicle. However, the driver may not always have the knowledge, presence-of-mind or the time to initiate the process of slowing the vehicle using the parking brake. Consequently, the aforementioned process of braking the vehicle during loss of hydraulic pressure can not always slow the vehicle quickly and in a safe manner.

Accordingly, a practical, economical braking system solving the aforementioned disadvantages and having the aforementioned advantages is desired.

### SUMMARY OF THE INVENTION

An aspect of the present invention is to provide a braking system for a vehicle having a pair of primary steering members that are independently steered. Each of the primary steering members further has a primary steering direction. The primary steering directions of the primary steering members are adapted to be substantially parallel when the vehicle is not braking. The primary steering directions of the primary steering members are further adapted to be substantially parallel to a direction of travel of the vehicle when the vehicle is not braking. However, the primary steering directions of the primary steering members are adapted to be non-parallel during braking of the vehicle. Furthermore, the primary steering directions of the primary steering members are adapted to be non-parallel to the direction of travel during braking of the vehicle. Therefore, the braking system provides a force to the vehicle opposite to the direction of travel to slow the vehicle.

Another aspect of the present invention is to provide a method of braking a vehicle comprising the step of providing the vehicle with a pair of primary steering members, each being independently steered and having a primary steering direction. The primary steering directions of the primary steering members are substantially parallel to each other and the direction of travel when the vehicle is not braking. The method also includes the step of turning the primary steering directions of each of the primary steering members such that the primary steering directions of each of the primary steering members are non-parallel to each other and to the direction of travel to thereby provide a force to the vehicle opposite to the direction of travel to slow the vehicle.

Yet another aspect of the present invention is to provide a method of responding to at least a partial failure of a primary brake system of a vehicle. The vehicle has a pair of steering members, with each steering member being independently steered and having a steering direction. The steering directions of the steering members are substantially parallel to each other and the direction of travel when the vehicle is not braking and when the primary braking system does not at least partially fail. The method comprises the steps of sensing the failure of the primary brake system and rotating the steering directions of each of the steering members such that the steering directions of each of the steering members are non-parallel to each other and to the direction of travel.

The secondary braking system is efficient in use, economical to install, capable of a long operable life, and particularly adapted for the proposed use.

These and other features, advantages, and objects of the present invention will be further understood and appreciated by those skilled in the art by reference to the following specification, claims and appended drawings.

### BRIEF DESCRIPTION OF THE DRAWINGS

FIG. 1 is a block diagram illustrating a vehicle embodying a braking system according to the present invention;

FIG. 2 is a block diagram illustrating the vehicle braking using a secondary braking system at a first orientation of the present invention;

FIG. 3 is a block diagram illustrating the vehicle braking using the secondary braking system at a second orientation of the present invention;

FIG. 4 is a block diagram illustrating the vehicle braking and turning using the secondary braking system at the first orientation of the present invention;

FIG. 5 is a block diagram illustrating the vehicle braking and turning using the secondary braking system at the second orientation of the present invention;

FIG. 6 is a block diagram illustrating the vehicle having four-wheel steering that is braking using the secondary braking system at the first orientation of the present invention; and

FIG. 7 is a block diagram illustrating a methodology for braking a vehicle using the braking system of the present invention.

### DETAILED DESCRIPTION OF THE PREFERRED EMBODIMENTS

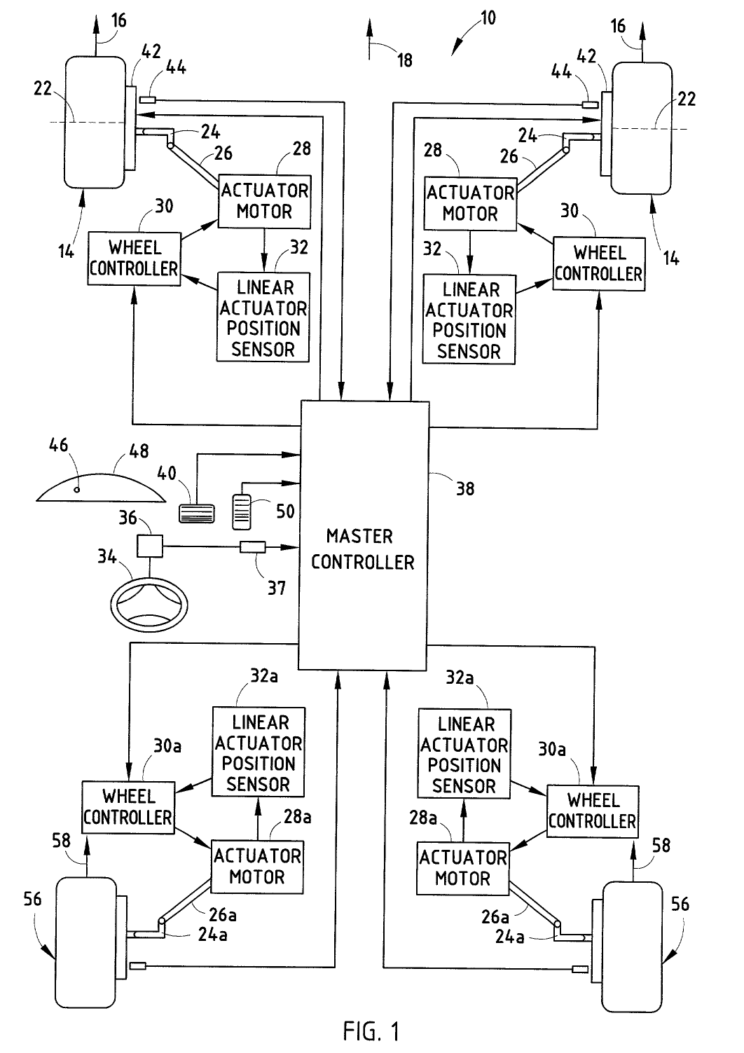

For purposes of description herein, the terms “upper,” “lower,” “right,” “left,” “rear,” “front,” “vertical,” “horizontal,” and derivatives thereof shall relate to the invention as orientated in FIG. 1. However, it is to be understood that the invention may assume various alternative orientations, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

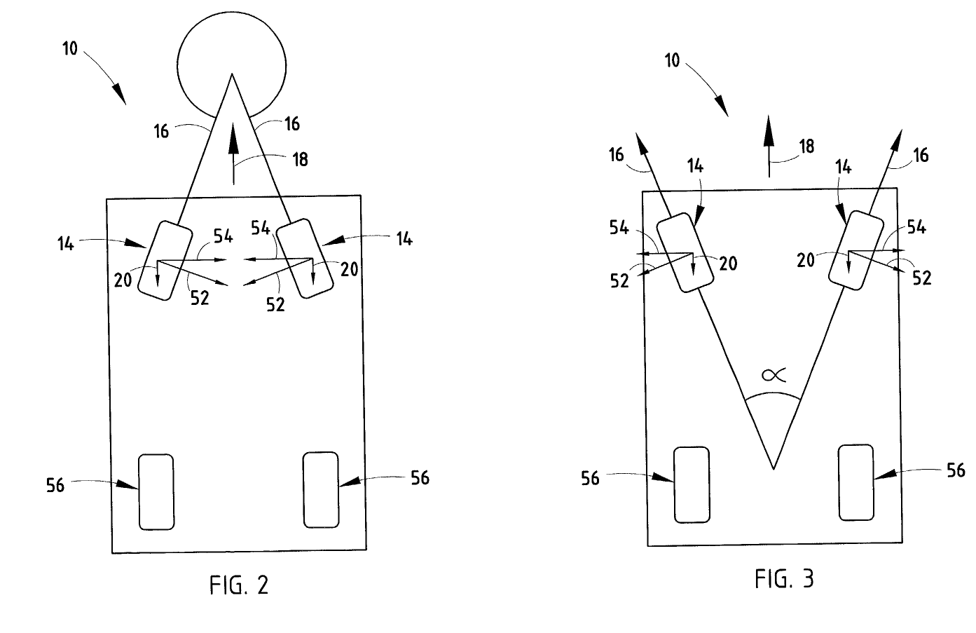

Referring to FIG. 1, reference number 10 generally designates a vehicle embodying the present invention. The vehicle 10 has a braking system including a pair of primary steering members 14 that are independently steered. Each of the primary steering members 14 further has a primary steering direction 16. The primary steering directions 16 of the primary steering members 14 are adapted to be substantially parallel when the vehicle 10 is not braking. The primary steering directions 16 of the primary steering members 14 are further adapted to be substantially parallel to a direction of travel 18 of the vehicle 10 when the vehicle 10 is not braking. However, as seen in FIG. 2, the primary steering directions 16 of the primary steering members 14 are non-parallel during braking of the vehicle 10. Furthermore, the primary steering directions 16 of the primary steering members 14 are non-parallel to the direction of travel 18 during braking of the vehicle 10. Therefore, the braking system 12 provides a force 20 to the vehicle 10 opposite to the direction of travel 18 to slow and decelerate the vehicle 10.

The illustrated primary steering members 14 of the vehicle 10 include a pair of front wheels steered independent of each other. The primary steering direction 16 is the direction in which the primary steering members 14 will direct the vehicle. In the illustrated example of front wheels 14 as the primary steering members 14, the primary steering direction 16 is defined as the direction perpendicular to the axis of rotation 22 of the front wheels 14. Preferably, the front wheels 14 of the vehicle 10 are independently steered to alter the primary steering direction 16 using a “steer-by-wire” system.

In the illustrated “steer-by-wire” system shown in FIG. 1, each of the wheels 14 is connected to a steering arm 24, which in turn is connected to a linear actuator 26. Each wheel 14 of the vehicle 10 is steered with an actuation motor 28 and a wheel controller 30. The actuation motor 28 is connected to the linear actuator 26 for actuating the wheel 14 to turn the wheel 14 left or right. It is contemplated, in an alternative embodiment of the steer-by-wire system, that the actuation motor 28 could actuate the steering arm 24 with a hydraulic system instead of the linear actuator 26. Each wheel controller 30 is associated with the actuation motor 28 to control the actuation motor 28. Furthermore, a linear actuator position sensor 32 monitors the position of the actuator motor 28 to measure the primary steering direction 16 of the wheel 14. In an alternative embodiment, the position sensor 32 could monitor the wheels 14 directly or any other element of the vehicle 10 that could be monitored to determine the primary steering direction of the wheel 14. In the preferred embodiment, the monitored position of the actuator motor 28 is input to the wheel controller 30. Accordingly, each front wheel 14 is independently steered by separately controlled actuator motors 28 and wheel controllers 30.

The illustrated vehicle 10 further includes a steering wheel 34 which is manually rotated by the driver of the vehicle 10 to change the primary steering directions 16 of the wheels 14. The steering wheel 34 includes a power steering motor 36 that provides an adequate amount of rotational resistance to realize easy and controlled steering of the vehicle 10. A steering wheel position sensor 37 monitors the rotational position of the steering wheel 34, either directly from the steering wheel shaft (not shown) or from the rotational resistance of the motor 36, and produces a steering wheel position signal. The position of the steering wheel 34 determines the direction of travel 18 of the vehicle 10. If the steering wheel 34 is not rotated, the direction of travel 18 of the vehicle 10 will move the vehicle 10 along a straight line path. When the steering wheel 34 is rotated, the direction of travel 18 of the vehicle 10 will move the vehicle 10 along a non-linear path.

In the illustrated example, the vehicle 10 further includes a master controller 38 for controlling overall steering operation of the vehicle 10. As described in more detail below, the master controller 38 also controls the braking system of the present invention. The master controller 38 may include a general purpose microprocessor-based controller, and may include a commercially available off-the-shelf controller. The master controller 38 preferably includes a processor and memory for storing and processing software algorithms which process sensed vehicle information and provide output control signals to the road wheel controllers 30 to control actuation of the corresponding wheels 14. Such steer-by-wire systems as the one described directly above are known to those skilled in the art. Although the braking system of the present invention is preferably used in a steer-by-wire system like the one described above, the braking system could be incorporated into any steering system whereby the primary steering members 14 of the steering system are independently steered.

The illustrated brake system of the vehicle 10 of the present invention preferably includes a primary braking system and a secondary braking system. The primary braking system includes a brake pedal 40 communicating with a pair of brake elements 42 located adjacent each front wheel 14. Preferably, the brake elements 42 are brake pads or shoes. The brake pedal 40 is located within the vehicle 10 and force is applied to the brake pedal 40 by a driver of the vehicle 10 to slow the vehicle under normal operating conditions. When the brake pedal 40 is depressed, hydraulic pressure causes the brake pads or shoes 42 to move into contact with rotors or shoes (not shown), respectively, of the front wheels 14 to thereby inhibit rotation of the front wheels 14 by friction. Preferably, the brake pedal 40 is directly connected to a master cylinder that applies the hydraulic pressure through slave cylinders to the brake pad or shoe 42. In an alternative embodiment, Electro Hydraulic Braking (EHB) could be employed wherein a sensor measures the force applied to the brake pedal 40 and that signal is transmitted through the master controller 38 (see FIG. 1) to electronically control the master cylinder for applying the hydraulic pressure to the brake pad or shoe 42. Consequently, applying a force to the brake pedal 40 will brake and decelerate the vehicle. As described in more detail below, the secondary braking system of the present invention will activate when the primary braking system fails.

During normal operation of the vehicle 10, when a driver of the vehicle 10 wants the vehicle 10 to slow, the driver will depress the brake pedal 40 and the brake pad or shoe 42 will come into contact with the rotor or drum, respectively, of the front wheel 14 to decelerate the vehicle 10 as described directly above. However, during failure of the primary braking system, depression of the brake pedal 40 will not cause the vehicle 10 to adequately slow. Failure of the primary braking system can include a total loss of hydraulic pressure to the brake pad or shoe 42 or any other failure wherein the rotation of the front wheels 14 is not inhibited in normal correlation to the force applied to the brake pedal 40. Furthermore, failure of the primary braking system can comprise a partial failure that includes a partial loss of hydraulic pressure to the brake pad or shoe 42. In the illustrated example, a sensor 44 is located adjacent the brake pad or shoe 42 to determine a loss of hydraulic pressure to the brake pad or shoe 42 for determining failure of the primary braking system. Preferably, the sensor 44 is fluidly connected to a fuild line that applies hydraulic pressure to the brake pad or shoe 42. Alternatively, it is contemplated that the sensor could be a wheel speed sensor of the type typically used in Anti-lock Braking Systems (ABS). The sensor for the ABS system could be used to determine primary braking system failure by comparing the force applied to the brake pedal 40 and the lack of wheel speed reduction to determine that the primary braking system has failed.

When the primary brake system of the illustrated invention fails, the sensor 44 will send the failure information to the master controller 38 in order to employ the secondary braking system. Preferably, when the primary braking system fails, an indicator 46 on a dash board 48 within the vehicle 10 will notify the driver of the vehicle 10 of the failure so the driver does not attempt to accelerate the vehicle 10 by applying force to a throttle or gas pedal 50. During normal operation of the vehicle 10 and the primary brake system, the primary steering directions 16 of the wheels 14 are substantially parallel to each other and to the direction of travel 18. The term “substantially parallel” as used herein includes a “toe” angle of the wheels 14 wherein a front of the wheels 14 are spaced farther apart than a rear of the wheels 14 to prevent shimmy. The “toe” angle is usually less than half of a degree. “Substantially parallel” also an “Ackerman angle” during turning of the vehicle. The “Ackerman angle” is discussed in more detail below. Once the secondary braking system is initiated, the primary steering directions 16 of the front wheels 14 of the vehicle 10 will turn in a direction non-parallel to each other and to the direction of travel 18 of the vehicle 10 (see FIGS. 2 and 3) such that a significant force will be applied to the vehicle in a direction opposite to the direction of travel 18 to slow and stop the vehicle 10. The primary steering directions 16 of the front wheels 14 can be non-parallel by turning each front wheel 14 inward such that an angle a between the primary steering directions 16 of the front wheels 14 is greater than 180° as seen from a front of the vehicle 10 during braking of the vehicle 10 as shown in FIG. 2. Alternatively, the primary steering directions 16 of the front wheels 14 can be non-parallel by turning each front wheel 14 outward such that an angle α between the primary steering directions 16 of the front wheels 14 is less than 180° as seen from a front of the vehicle 10 during braking of the vehicle 10 as shown in FIG. 3.

As seen in FIG. 2, when the angle α between the primary steering directions 16 of the front wheels 14 is greater than 180°, each front wheel 14 will have a lateral force 52 in a direction towards the center of the vehicle 10. Similarly, as seen in FIG. 3, when the angle α between the primary steering directions 16 of the front wheels 14 is less than 180°, each front wheel 14 will have a lateral force 52 in a direction away from the center of the vehicle 10. The lateral force 52 will be perpendicular to the primary steering direction 16 of the individual front wheel 14 along the axle of the front wheel 14. The lateral force 52 for each front wheel 14 will have a lateral component 54 perpendicular to the direction of travel 18 of the vehicle 10 as the direction of travel 18 of the vehicle 10 is a straight line path. The lateral component 54 of the lateral force 52 for each front wheel 14 will be equal and opposite such that the vehicle 10 will be able to maintain the straight line path for the direction of travel 16. The lateral force 52 will also have a longitudinal component opposite to the direction of travel 16 of the vehicle 10. The longitudinal component of the lateral force 52 provides the force 20 to the vehicle 10 opposite to the direction of travel 18 that slows the vehicle 10.

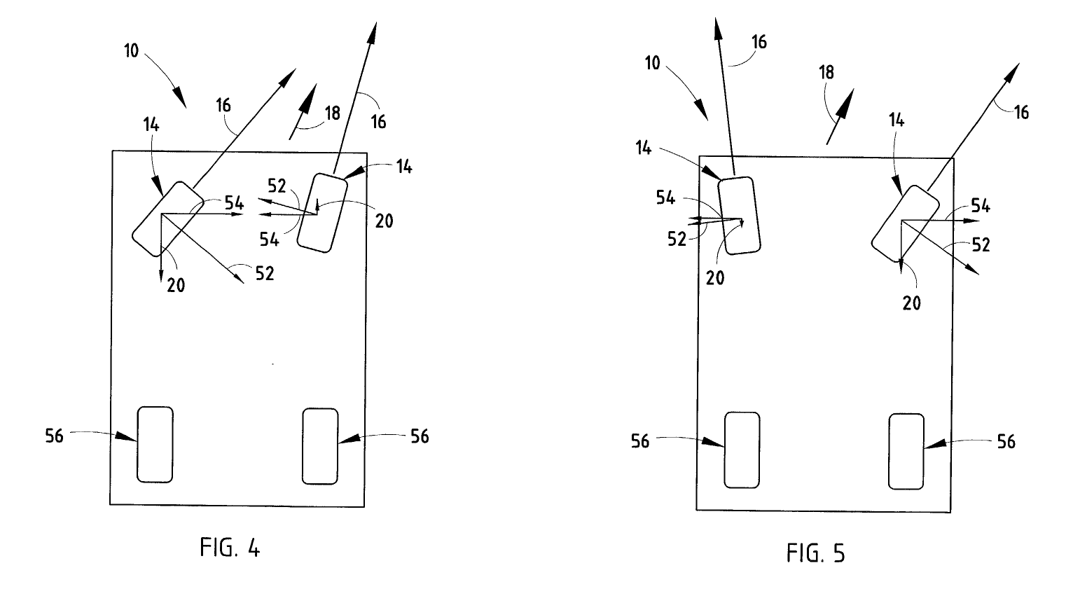

The illustrated vehicle 10 will also have the force 20 opposite to the direction of travel 18 to slow the vehicle 10 when the steering wheel 34 is rotated when the primary braking system fails. When the steering wheel 34 is rotated, the direction of travel 18 of the vehicle 10 will move the vehicle 10 along a non-linear path. During normal operation of the vehicle 10, the primary steering directions 16 of the wheels 14 will remain “substantially parallel” to each other as the vehicle 10 turns. When the vehicle 10 is turning, “substantially parallel” includes the “Ackerman angle.” An “Ackerman angle” allows the inside wheel 14 to follow a smaller radius than the outside wheel 14 when cornering. The correct “Ackerman angle” would allow either wheel 14 to follow its required radius, no matter what the turn radius was. Consequently, the force 20 is not applied to the vehicle 10 as the vehicle 10 is turned using the “Ackerman angle.” Wheels 14 having an “Ackerman angle” are known to those skilled in the art. When the direction of travel 18 points towards the right to turn the vehicle 10 right, the primary steering directions 16 of the wheels 14 will continue to be non-parallel to each other and to the direction of travel 18 such that the primary steering directions 16 of the front wheels 14 is greater than 180° as shown in FIG. 4, or less than 180° as shown in FIG. 5. When the direction of travel 18 of the vehicle 10 turns towards the right, the lateral component 54 of the lateral force 52 will have a net force towards the right. For example, the lateral force 52 of both front wheels 14 may be in a direction towards the right relative to the vehicle (FIG. 4) such that the net lateral component 54 of the lateral force 52 of each front wheels 14 is positive towards the right. Furthermore, the net force 20 will continue to be in a direction opposite to the direction of travel 18. Alternatively, the lateral force 52 of both front wheels 14 may be facing outward with the net lateral component 54 of the lateral force 52 of the front wheels 14 combined being positive towards the right (FIG. 5). Consequently, in the illustrated example, the net lateral component 54 of the lateral force 52 will turn the vehicle towards the right. Likewise, when the direction of travel 18 points to the left, the lateral force 52 will continue to provide the force 20 opposite to the direction of travel 18 of the vehicle 10 to slow the vehicle 10. Therefore, a driver of the vehicle 10 will be able to simultaneously steer the vehicle 10 with the steering wheel 34 and brake the vehicle 10 using the secondary brake system.

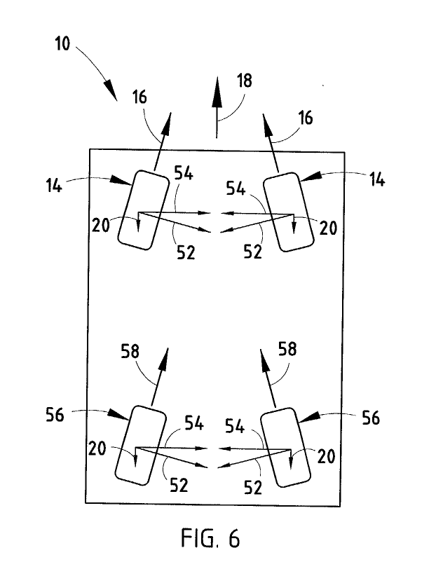

In the illustrated example, the vehicle 10 also includes a pair of rear wheels 56 (FIG. 1). If the vehicle 10 has four-wheel steering, the rear wheels 56 can be used in the secondary braking system to slow the vehicle 10 in the same manner as the front wheel 14. Therefore, to use the rear wheels 56 to slow the vehicle using the secondary braking system of the present invention, the pair of rear wheels 56 must be independently steered. Consequently, each rear wheel 56 has a rear wheel steering direction 58. The rear wheel steering directions 58 of the rear wheels 56 are parallel to each other and to the direction of travel 18 of the vehicle 10 when the vehicle 10 is not braking or when the primary braking system is working properly. However, the rear wheel steering directions 58 of the rear wheels 16 are non-parallel to each other and to the direction of travel 18 of the vehicle 10 during braking of the vehicle 10 when there is a failure of the primary braking system as shown in FIG. 6.

In the illustrated “steer-by-wire” system (FIG. 1), each of the rear wheels 56 is connected to a steering arm 24a, which in turn is connected to a linear actuator 26a. Each rear wheel 56 of the vehicle 10 is steered with an actuation motor 28a and a wheel controller 30a. The actuation motor 28a is connected to the linear actuator 26a for actuating the rear wheel 56 to turn the rear wheel 56 left or right. Each wheel controller 30a is associated with the actuation motor 28a to control the actuation motor 28a. Furthermore, a linear actuator position sensor 32a monitors the position of the actuator motor 28a to measure the rear wheel steering direction 58 of the rear wheel 56. In the preferred embodiment, the monitored position of the actuator motor 28a is input to the wheel controller 30a. Accordingly, each rear wheel 56 is independently steered by separately controlled actuator motors 28a and wheel controllers 30a. Preferably, during low speeds each right rear wheel 56 is steered in a direction opposite the right front wheel 14 and each left rear wheel 56 is steering in a direction opposite the left front wheel 14. Therefore, during turning of the vehicle 10 at low speeds, the front wheels 14 will move the front of the vehicle 10 in one direction (e.g., right) and the rear wheels 56 will move the vehicle 10 in the opposite direction (e.g., left). However, at high speeds, both the front wheels 14 and the rear wheels 56 are steered in the same direction to assist in lane changing. Similar to the wheel controllers 30 for the front wheels 14, the wheel controllers 30a for the rear wheels 56 receive information and control from the master controller 38. Such four-wheel steering systems as the one described directly above are known to those skilled in the art.

When the vehicle 10 has four wheel steering, the front wheels 14 can be non-parallel to each other and to the direction of travel 18 of the vehicle 10 and the rear wheels 56 can be non-parallel to each other and to the direction of travel 18 of the vehicle 10 during braking of the vehicle 10 when there is a failure of the primary braking system (see FIG. 6). Alternatively, only the front wheels 14 or only the rear wheels 56 could be non-parallel to each other and to the direction of travel 18 of the vehicle 10 when there is a failure of the primary braking system. Additionally, both the primary steering directions 16 of the front wheels 14 and the rear wheel steering directions 58 of the rear wheels 56 can be greater than 180° or less than 180° as described above. Alternatively, the primary steering direction 16 of the front wheels 14 and the rear wheel steering directions 58 of the rear wheels 56 can have opposite orientations (i.e., one greater than 180° and one less than 180°). With four-wheel steering, the rear wheels 56 will have the lateral force 52 with the lateral component 54 and the force 20 similar to the front wheels 14 during braking of the vehicle 10 with the second braking system (see FIG. 6).

In a preferred embodiment, a greater force 20 is applied to the vehicle 10 by the front wheels 14 (and the rear wheels 56) to slow the vehicle 10 as a greater force is applied to the brake pedal 40. Therefore, the angle α between the primary steering directions 18 of the front wheels 14 (and the rear wheel steering directions 58 of the rear wheels 56) increases in proportion to the force applied to the brake pedal 40 if the angle a between the primary steering directions 16 of the front wheels 14 (and the rear wheel steering directions 58 of the rear wheels 56) is less than 180° as seen from the front of the vehicle 10 during braking of the vehicle 10. Likewise, the angle a between the primary steering directions 18 of the front wheels 14 (and the rear wheel steering directions 58 of the rear wheels 56) decreases in proportion to the force applied to the brake pedal 40 if the angle α between the primary steering directions 16 of the front wheels 14 (and the rear wheel steering directions 58 of the rear wheels 56) is less than 180° as seen from the front of the vehicle 10 during braking of the vehicle 10.

It is further contemplated that a speedometer and an accelerometer (not shown) could be connected to the master controller 38 such that the angle α between the primary steering directions 16 of the front wheels 14 will move in proportion to the speed of the vehicle 10. Preferably, the primary steering directions 16 of the front wheel 14 will move closer to being parallel to each other and to the direction of travel 18 when the vehicle 10 is traveling at a higher speed than when the vehicle 10 is traveling at a slower speed. Since the wheels 14 are angled relative to the direction of travel 18 of the vehicle 10 during braking using the secondary braking system, the vehicle 10 will be travelling at a speed different than the rotational speed of the wheels 14. Therefore, the speedometer is used to determine the speed of the vehicle 10 before the secondary braking system is employed, while readings from the accelerometer could be used to estimate the speed of the vehicle 10 after the secondary steering system was used for deceleration. However, accelerometers would only be required in a four wheel steer vehicle 10 because the rotational speed of all four wheels 14 and 56 in this system would be different than the speed of the vehicle 10. In a two wheel steer vehicle 10, accurate speed readings could be determined from the rotation speed of the rear wheels 56 because they are not angled and they are travelling at the same speed as the vehicle 10.

In the illustrated example, the angle α between the primary steering directions 18 of the front wheels 14 (and the rear wheel steering directions 58 of the rear wheels 56), if the angle α between the primary steering directions 16 of the front wheels 14 (and the rear wheel steering directions 58 of the rear wheels 56) is less than 180° as described above, it will preferably be greater when the vehicle 10 is traveling along a straight ground path than when a driver of the vehicle 10 is turning the steering wheel 34. Likewise, the angle a between the primary steering directions 18 of the front wheels 14 (and the rear wheel steering directions 58 of the rear wheels 56), if the angle α between the primary steering directions 16 of the front wheels 14 (and the rear wheel steering directions 58 of the rear wheels 56) is greater than 180° as described above, it will preferably be less when the vehicle 10 is traveling along a straight ground path than when a driver of the vehicle 10 is turning the steering wheel 34. However, if the driver of the vehicle 10 continues to rotate the steering wheel 34, the secondary braking system preferably reduces the force 20 on the vehicle 10 and the primary steering directions 18 become closer to being parallel with the direction of travel 18 of the vehicle 10 to allow the driver more control over the direction of travel 18 of the vehicle 10.

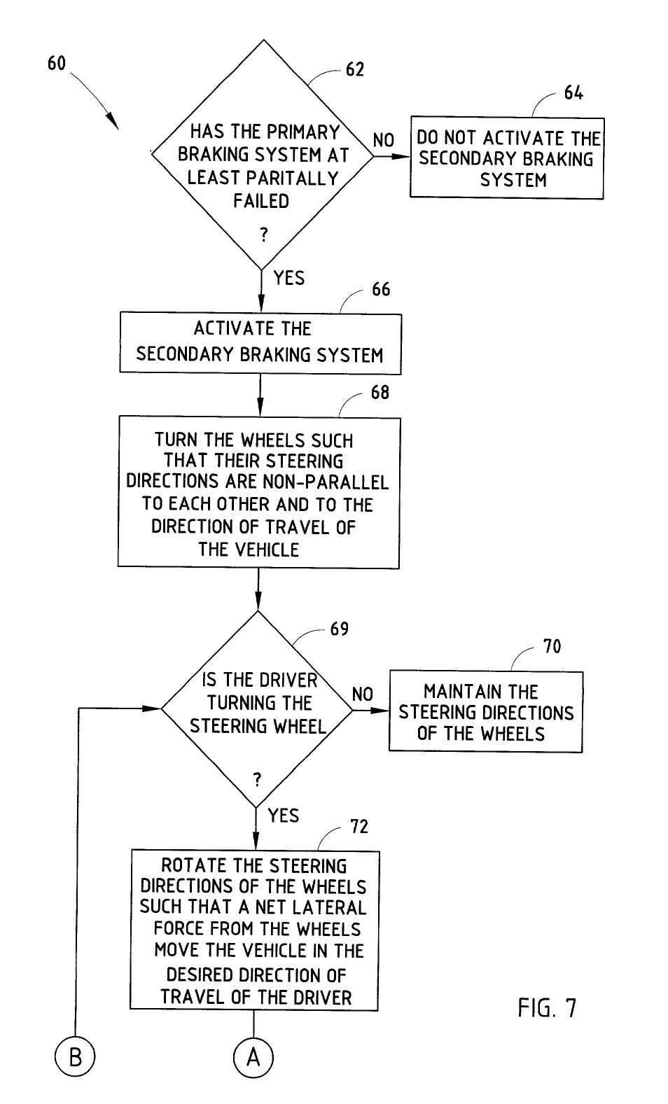

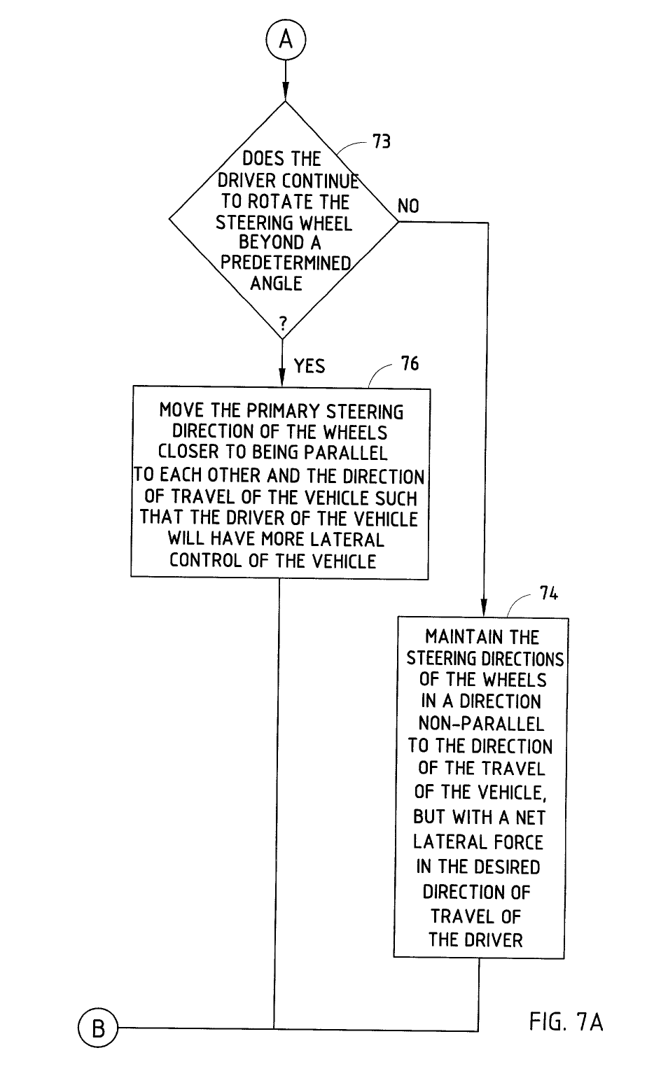

Referring to FIG. 7, a method of braking 60 a vehicle is shown for braking the vehicle 10 that has the primary braking system and the secondary braking system according to the present invention. Beginning at a first step 62 of the method of braking 60, the sensor 44 will determine if there has been at least a partial failure of the primary braking system. If there has not been at least a partial failure of the primary braking system, the method of braking 60 will proceed to step 64 wherein the secondary braking system will not activate. If there has been at least a partial failure of the primary braking system, the method of braking 60 will proceed to step 66 and activate the secondary braking system. Once the secondary braking system is activated in step 66, the wheels 14 of the vehicle 10 will turn such that their primary steering directions 16 are non-parallel to each other and to the direction of travel 18 of the vehicle 10 at step 68. Thereafter, at step 69 of the method of braking 60, the master controller 38 of the vehicle 10 will determine if the driver of the vehicle 10 is turning the steering wheel 34. If the driver of the vehicle 10 is not rotating the steering wheel 34, the method of braking 60 the vehicle will proceed to step 70 wherein the primary steering directions of the wheels 16 will maintain their direction in response to pressure applied to the brake pedal 40 as described above. If the driver of the vehicle is rotating the steering wheel 34, the method of braking 60 the vehicle will proceed to step 72 wherein the primary steering directions of the wheels 16 will rotate such that there is a net lateral force applied to the vehicle 10 to move the vehicle 10 laterally along the direction of travel 18 and will continue to apply the force 20 to the vehicle 10 to slow the vehicle 10. Thereafter, at step 73 of the method of braking 60, the master controller 30 will determine if the driver of the vehicle continues to rotate the steering wheel 34 of the vehicle 10 past a predetermined angle (e.g. over 180°). The predetermined angle is preferably determined from the speed of the vehicle 10, lateral acceleration of the vehicle 10, longitudinal acceleration of the vehicle 10 and/or the pressure applied to the brake pedal 40. If the driver of the vehicle 10 does not rotate the steering wheel 34 of the vehicle 10 past the predetermined angle, the method of braking 60 will proceed to step 74 in which the steering direction 16 of the wheels 14 is maintained in a direction non-parallel to the direction of travel 18 of the vehicle 10, but with a net lateral force in the desired direction of travel 18. However, if the driver of the vehicle 10 rotates the steering wheel 34 of the vehicle 10 past the predetermined angle, the method of braking 60 will proceed to step 76 wherein the primary steering directions 16 of the wheels 14 are moved closer to being parallel to the direction of travel 18 of the vehicle 10 such that the driver of the vehicle 10 will have more lateral control of the vehicle 10. Once the driver of the vehicle 10 has moved the steering wheel 34 and the method of braking 60 has moved to either step 74 or step 76, the method of braking 60 will go back to step 69 of the method of braking 60.

In the vehicle 10 of the present invention, the vehicle 10 will be able to slow when the primary braking system at least partially fails so that the vehicle may safely slow and come to a stop for the safety of the driver and any passengers in the vehicle 10. The braking system of the present invention will work in any vehicle having independently steered steering members. Preferably, the braking system of the present invention will be employed in a steer-by-wire system wherein the master controller 30 in the steer-by-wire system will control the secondary braking system when the primary braking system at least partially fails.

In the forgoing description, it will be readily appreciated by those skilled in the art that modifications may be made to the invention without departing from the concepts disclosed herein. Such modifications are to be considered as included in the following claims, unless these claims by their language expressly state otherwise.

We claim:

1. A braking system for a vehicle comprising:
a pair of primary steering members, each primary steering member being independently steered, each primary steering member further having a primary steering direction;
the primary steering directions of the primary steering members being adapted to be substantially parallel when the vehicle is not braking, the primary steering directions of the primary steering members further being adapted to be substantially parallel to a direction of travel of the vehicle when the vehicle is not braking; and
the primary steering directions of the primary steering members being adapted to be non-parallel during braking of the vehicle, the primary steering directions of the primary steering members further being adapted to be non-parallel to the direction of travel during braking of the vehicle, thereby providing a force to the vehicle opposite to the direction of travel to slow the vehicle.

2. The braking system for vehicle of claim 1, wherein:
the primary steering members comprise wheels, the wheels being configured to move the vehicle in the direction of travel by rotation of the wheels, each of the wheels further having an axis of rotation; and
the primary steering direction of each of the wheels being perpendicular to the axis of rotation of the wheel; and
further including a primary braking system for inhibiting the rotation of the wheels;
the primary steering direction of the wheels being adapted to be substantially parallel during braking when the primary braking system does not at least partially fail; and
the primary steering direction of the wheels being adapted to be non-parallel when the primary braking system at least partially fails.

3. The braking system for a vehicle of claim 2, wherein:
the wheels are front wheels adapted to be located adjacent a front end of the vehicle on opposite sides of the vehicle; and
further including a pair of rear wheels adapted to be located adjacent a rear end of the vehicle on opposite sides of the vehicle;
the pair of rear wheels being independently steered, each rear wheel further having a rear wheel steering direction;
the rear wheel steering directions of the rear wheels being adapted to be substantially parallel when the vehicle is not braking and when the vehicle is braking when the primary braking system does not at least partially fail, the rear wheel steering directions of the rear wheels further being adapted to be substantially parallel to a direction of travel of the vehicle when the vehicle is not braking and when the vehicle is braking when the primary braking system does not at least partially fail; and
the rear wheel steering directions of the rear wheels being adapted to be non-parallel during braking of the vehicle when the primary braking system at least partially fails, the rear wheel steering directions of the rear wheels further being adapted to be non-parallel to the direction of travel during braking of the vehicle when the primary braking system at least partially fails, thereby providing a force to the vehicle opposite to the direction of travel to slow the vehicle.

4. The braking system for a vehicle of claim 2, further including:
a brake pedal being adapted to brake the vehicle by applying a force to the brake pedal.
wherein the primary steering directions of the wheels are adapted to diverge in proportion to the force applied to the brake pedal when the primary braking system at least partially fails.

5. The braking system for a vehicle of claim 2, further including:
a sensor for determining at least partial failure of the primary braking system.

6. The braking system for a vehicle of claim 5, further including:
an indicator for notifying a driver of the vehicle of the at least partial failure of the primary braking system.

7. The braking system for a vehicle of claim 2, further including:
a steering wheel for steering the vehicle along the direction of travel, the steering wheel being configured to be rotated for altering the direction of travel of the vehicle;
wherein the primary steering directions of the wheels continue to be non-parallel as the steering wheel is rotated to alter the direction of travel of the vehicle, thereby allowing a driver of the vehicle to simultaneously alter the direction of the travel of the vehicle and slow the vehicle.

8. A method of braking a vehicle comprising:
providing the vehicle with a pair of primary steering members, each primary steering member being independently steered and having a primary steering direction, the primary steering directions of the primary steering members being substantially parallel to each other and the direction of travel when the vehicle is not braking; and
turning the primary steering members such that the primary steering directions of each of the primary steering members are non-parallel to each other and to the direction of travel to thereby provide a force to the vehicle opposite to the direction of travel to slow the vehicle.

9. The method of braking a vehicle of claim 8, wherein:
the primary steering members comprise wheels, the wheels being configured to move the vehicle in the direction of travel by rotation of the wheels; and
further including the step of providing the vehicle with a primary braking system for inhibiting the rotation of the wheels;
wherein the step of turning the primary steering members such that the primary steering directions of each of the primary steering members are non-parallel to each other and to the direction of travel occurs when the primary braking system at least partially fails.

10. The method of braking a vehicle of claim 9, further including:
locating the wheels adjacent a front end of the vehicle on opposite sides of the vehicle;
locating a pair of rear wheels adjacent a rear end of the vehicle on opposite sides of the vehicle, the pair of rear wheels being independently steered, each rear wheel further having a rear wheel steering direction, the rear wheel steering directions of the rear wheels being substantially parallel when the vehicle is not braking, the rear wheel steering directions of the rear wheels further being substantially parallel to a direction of travel of the vehicle when the vehicle is not braking; and
turning the rear wheels such that the rear steering directions of each of the rear wheels are non-parallel to each other and to the direction of travel to thereby provide an additional force to the vehicle opposite to the direction of travel to slow the vehicle;
wherein the step of turning the rear wheels such that the rear steering directions of each of the rear wheels are non-parallel to each other and to the direction of travel occurs when the primary braking system at least partially fails.

11. The method of braking a vehicle of claim 9, further including:
providing the vehicle with a brake pedal for braking the vehicle by applying a force to the brake pedal; and
diverging the primary steering directions of the front wheels in proportion to the force applied to the brake pedal.

12. The method of braking a vehicle of claim 9, further including:
providing the vehicle with a sensor for determining at least partial failure of the primary braking system.

13. The method of braking a vehicle of claim 12, further including:
providing the vehicle with an indicator for notifying a driver of the vehicle of the at least partial failure of the primary braking system.

14. The method of braking a vehicle of claim 9, further including:
providing the vehicle with a steering wheel for steering the vehicle along the direction of travel;
rotating the steering wheel to alter the direction of travel of the vehicle; and
maintaining the primary steering directions of the wheels in a non-parallel direction to each other during the step of rotating the steering wheel, thereby allowing a driver of the vehicle to simultaneously alter the direction of the travel of the vehicle and slow the vehicle.

15. A method of responding to at least a partial failure of a primary brake system of a vehicle, the vehicle having a pair of steering members, each steering member being independently steered and having a steering direction, the steering directions of the steering members being substantially parallel to each other and the direction of travel when the vehicle is not braking and when the primary brake system does not at least partially fail, the method comprising the steps of:
sensing the failure of the primary brake system; and
rotating the steering directions of each of the steering members such that the steering directions of each of the steering members are non-parallel to each other and to the direction of travel.

16. The method of responding to at least a partial failure of a primary brake system of a vehicle of claim 15, wherein:
the primary steering members comprise wheels, the wheels moving the vehicle in the direction of travel by rotation of the wheels, wherein the primary braking system inhibits the rotation of the wheels.

17. The method of responding to at least a partial failure of a primary brake system of a vehicle of claim 16, further including:
locating the wheels adjacent a front end of the vehicle on opposite sides of the vehicle;
locating a pair of rear wheels adjacent a rear end of the vehicle on opposite sides of the vehicle, the pair of rear wheels being independently steered, each rear wheel further having a rear wheel steering direction, the rear wheel steering directions of the rear wheels being substantially parallel when the vehicle is not braking and when the primary braking system does not at least partially fail, the rear wheel steering directions of the rear wheels further being substantially parallel to a direction of travel of the vehicle when the vehicle is not braking and when the primary braking system does not at least partially fail; and
turning the rear steering directions of each of the rear wheels such that the rear steering directions of each of the rear wheels are non-parallel to each other and to the direction of travel to thereby provide an additional force to the vehicle opposite to the direction of travel to slow the vehicle.

18. The method of responding to primary brake system failure of a vehicle of claim 17, further including:
providing the vehicle with a brake pedal for braking the vehicle by applying a force to the brake pedal; and
diverging the primary steering directions of the front wheels and the rear steering directions of the rear wheels in proportion to the force applied to the brake pedal.

19. The method of responding to primary brake system failure of a vehicle of claim 15, further including:
providing the vehicle with an indicator for notifying a driver of the vehicle of the at least partial failure of the primary braking system.

20. The method of responding to primary brake system failure of a vehicle of claim 15, further including:
providing the vehicle with a steering wheel for steering the vehicle along the direction of travel;
rotating the steering wheel to altering the direction of travel of the vehicle; and
maintaining the primary steering directions of the primary steering members in a direction non-parallel to each other during the step of rotating the steering wheel, thereby allowing a driver of the vehicle to simultaneously alter the direction of the travel of the vehicle and slow the vehicle.
